(19) United States
(12) Patent Application Publication
(10) Pub. No.: US 2006/0133344 A1
(43) Pub. Date: Jun. 22, 2006

(54) Method for reproducing AMR message in mobile telecommunication terminal

(75) Inventor: Byung-Han Kang, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/299,995

(22) Filed: Dec. 12, 2005

(30) Foreign Application Priority Data
Dec. 16, 2004 (KR) 10-2004-0106973

(51) Int. Cl. H04J 3/24; H04J 3/22

(52) U.S. Cl. 370/349; 370/465

(57) ABSTRACT

A method for reproducing an AMR message in a mobile telecommunication terminal, the method including the steps of receiving an adaptive multi-rate message decoded by an adaptive multi-rate codec and measuring an overall size of the adaptive multi-rate message, creating plural division adaptive multi-rate message files, each of which is formed by grouping frames in the AMR message based on a predetermined division unit, and reproducing a division adaptive multi-rate message file selected by a user from among the created division adaptive multi-rate message files.

### PRIORITY

This application claims priority to an application entitled “Method for Reproducing AMR Message in Mobile Telecommunication Terminal” filed in the Korean Intellectual Property Office on Dec. 16, 2004 and assigned Serial No. 2004-106973, the contents of which are incorporated herein by reference.

### BACKGROUND OF THE INVENTION

1. Field of the Invention

The present invention relates to a method for reproducing an AMR (Adaptive Multi-Rate) message used for an MMS (Multimedia Messaging Service) message decoded through an AMR codec (variable codec) in a mobile telecommunication terminal, and more particularly to a method for reproducing a division file made by grouping plural AMR frames included in an AMR message based on a predetermined unit.

2. Description of the Related Art

In wireless digital communication, analog voice information is coded into digital information, and the digital information must be channel-coded prior to transmission in order to ensure proper speech quality when receiving the digital information. For example, typical GSM employs a speech codec at a fixed rate for speech coding. One such GSM system employs two full-rate voice codecs and one half-rate voice codec. The full-rate voice codecs each have an output bit rate of 13 kbit/s or 12.2 kbit/s. In contrast, the half-rate voice codec has an output bit rate of 5.6 kbit/s. Herein, the output bits representing coded vocal parameters are provided to a channel coder. In the meantime, channel coding may add redundancy bits to an information sequence. Generally, such channel coding is achieved with respect to input bits of a fixed size. In the channel coder, a full-rate channel may be adjusted to an output bit rate of 22.8 kbit/s and a half-rate channel may be adjusted to an output bit rate of 11.4 kbit/s. Accordingly, the above-mentioned typical GSM codec employs a fixed division scheme between bit rates of speech coding and channel coding regardless of channel quality. The above-mentioned bit rate is achieved through a fixed codec scheme which is never changed without a communication channel change, and the bit rate is lowered due to the fixed codec scheme.

Accordingly, in order to optimize system capacity and achieve desirable speech quality, an AMR (adaptive multi-rate) codec, which is a variable codec, has been developed. In other words, the AMR codec employing a dynamic division scheme between bit rates of speech coding and channel coding has been developed and standardized in order to improve synthetic speech quality. The AMR codec employs a variable codec adjusting a division scheme between the bit rates of speech coding and channel coding according to channel quality in order to provide the best synthetic speech quality. An AMR speech coder includes a multi-rate speech coder, a source controlled rate scheme including a voice activity detector and a comfort noise generation system, and an error concealment mechanism to combat the effects of transmission errors and lost packets. The multi-rate speech coder is realized as a single integrated speech codec having eight basic source rates which range from 4.75 kbit/s to 12.2 kbit/s, and a low rate background noise coding mode.

In the meantime, a mobile telecommunication terminal (e.g., a GSM terminal) must have an AMR decoder such that the mobile telecommunication terminal may receive an AMR message of the AMR codec and reproduce the AMR message through a specific function. For example, when the GSM terminal extracts the AMR message from an MMS (multimedia messaging service) message and reproduces the AMR message by using the AMR codec, the GSM terminal must have the AMR decoder in order to carry out specific reproduction functions such as forwarding, rewinding, jumping, i.e., moving to a desired position. In addition, the AMR decoder must exactly detect a position of a desired specific frame in the AMR message in order to carry out the specific reproduction function. However, in order to detect the position of the specific frame whenever the AMR decoder performs the specific reproduction function as described above, the AMR decoder heavily loads a CPU (Central Processing Unit) which runs the system. That is, in order to receive an AMR message coded through a variable codec scheme in which a transmission rate of voice data on a channel varies, and to reproduce the AMR message from a desired position, the AMR decoder in the terminal separately detects sizes of all frames in headers of the frames and moves to the desired position. In other words, the AMR decoder separately detects the sizes of all frames (e.g., several thousands of frames to several millions of frames as are typically used) by primarily scanning a header of each frame in order to move to a desired position as described above. After that, the AMR decoder moves to the desired position and reproduces the AMR message. Unfortunately, this processing load causes a terminal's CPU to be heavily loaded which can, in certain circumstances, lead to an overload of the CPU and result in system slowdowns and/or crashes.

### SUMMARY OF THE INVENTION

Accordingly, the present invention has been made to solve the above-mentioned problems occurring in the prior art, and an object of the present invention is to provide a method for reproducing an AMR message, which can prevent an overload of a CPU during the reproduction of the AMR message.

It is another object of the present invention to provide a method which can divide an AMR message based on a predetermined unit.

It is still another object of the present invention to provide a method which can reproduce an AMR message at a specific position while reducing the load of a CPU as compared to conventional methods.

To accomplish the above objects, there is provided a method for reproducing an AMR message in a mobile telecommunication terminal, the method including the steps of receiving an adaptive multi-rate message decoded by an adaptive multi-rate codec and measuring an overall size of the adaptive multi-rate message, creating plural division adaptive multi-rate message files, each of which is formed by grouping frames in the AMR message based on a predetermined division unit, and reproducing a division adaptive multi-rate message file selected by a user from among the created division adaptive multi-rate message files. The division adaptive multi-rate message file reproducing step includes the steps of, displaying division adaptive multi-rate message files of the adaptive multi-rate message requested to be reproduced, moving to a division adaptive multi-rate message file selected by a user and reproducing the selected division adaptive multi-rate message file, sequentially reproducing next frames up to a final adaptive multi-rate message file after finishing reproduction of the adaptive multi-rate message file, and when the user requests reproduction of another adaptive multi-rate message file during reproduction of the adaptive multi-rate message file, moving to the requested division adaptive multi-rate file and reproducing the requested division adaptive multi-rate message file.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a structure of an AMR decoder according to the present invention;

FIG. 2 is a view illustrating an AMR frame transmitted to a terminal;

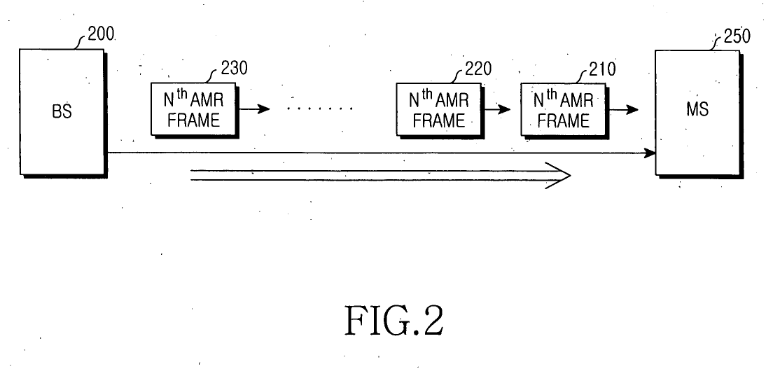

FIG. 3 is a view illustrating a format of an AMR frame at an AMR codec mode “4”;

FIG. 4 is a view illustrating a scanning procedure for AMR frames included in an AMR message;

FIG. 5 is a view illustrating storage information in a division AMR message file;

FIG. 6 is a flowchart illustrating a procedure of creating a division AMR message file;

FIG. 7 is a flowchart illustrating a procedure of reproducing an AMR message; and

FIG. 8 is an exemplary screenshot illustrating a list of division AMR message files displayed on an LCD window.

### DETAILED DESCRIPTION OF THE PREFERRED EMBODIMENT

Hereinafter, one preferred embodiment of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

According to one embodiment of the present invention, a mobile telecommunication terminal will be described as a GSM terminal for reproducing an AMR codec (adaptive multi-rate codec) message in a GSM system. However, it is well-known to those skilled in the art that the present invention is not limited only to the GSM system, but can also be applied to other systems, such as a CDMA terminal of WCDMA (wide band code division multiple access) supporting the AMR codec. Following Table 1 represents operation modes of the AMR codec.

TABLE 1

| | AMR codec mode | The number of bits/20 ms |
|---|---|---|
| AMR codec mode No. | operation | frame |
| 0 (AMR 4.75) | 4.75 kbit/s speech | 95 bits |
| 1 (AMR 5.15) | 5.15 kbit/s speech | 103 bits |
| 2 (AMR 5.90) | 5.90 kbit/s speech | 118 bits |
| 3 (AMR 6.70) | 6.70 bits/s speech | 134 bits |
| 4 (AMR 7.40) | 7.40 kbit/s speech | 148 bits |
| 5 (AMR 7.95) | 7.95 kbit/s speech | 159 bits |
| 6 (AMR 10.2) | 10.2 kbit/s speech | 204 bits |
| 7 (AMR 12.2) | 12.2 kbit/s speech | 244 bits |
| 0 (AMR SID) | AMR SID | 39 bits |

The AMR message is first stored in a terminal such that the AMR message is used for the MMS or the E-Mail at a later time. Accordingly, the following AMR message is stored in the form of a file through the AMR codec for communication. Herein, the AMR codec applies error correction measures to a wireless channel and communication, and the optimum channel and the optimum codec mode (speech and channel speeds) are selected, thereby assuring desired communication quality. To this end, the AMR codec has eight different AMR codec modes within the range of bit rates of 4.75 kbit/s to 12.2 kbit/s and one AMR codec mode for transmitting an SID (silence indicator) as shown in Table 1. As a result, in the AMR codec modes, the number of bits in the frame of 20 ms is within 244 bits.

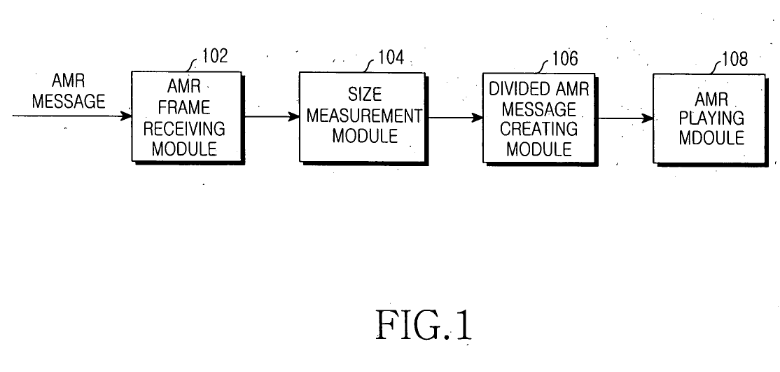

FIG. 1 is a block diagram illustrating a structure of an AMR decoder according to the present invention. More specifically FIG. 1 illustrates each function module of an AMR decoder in the mobile telecommunication terminal according to one embodiment of the present invention. Generally, the GSM system transmits a plurality of media messages (including the AMR message) packaged in an MMS message. Herein, an AMR frame receiving module 102 extracts only AMR frames included in AMR messages from the received MMS message.

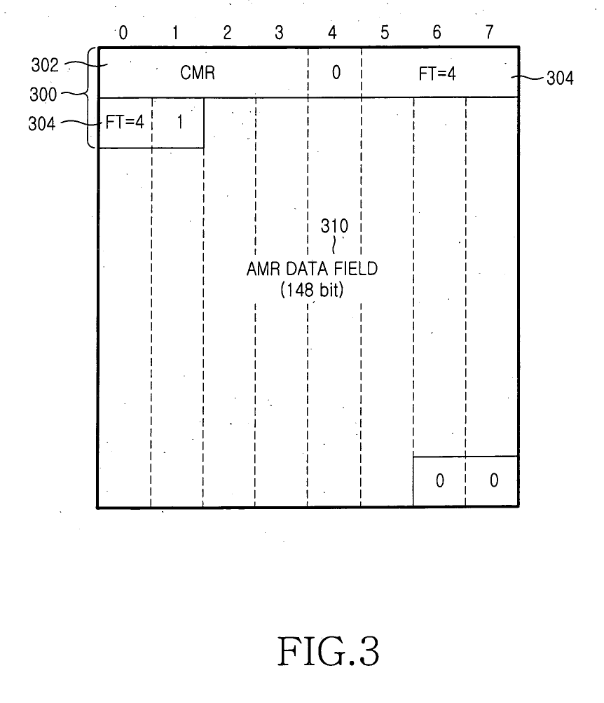

A size measurement module 104 determines the size of bits in each AMR frame. Thus, since the size measurement module 104 can measure the size of each AMR frame, the summation for the sizes of the whole AMR frames may be found. In the meantime, if the AMR message has plural single frames (as opposed to multi-frames), one AMR frame includes a CMR 302, a header field (corresponding to a duration of bits 0-9) 300 including an AMR codec mode number (FT (Frame Type Index) in a duration of bits 5-8) 304, and an AMR data field 310 (as shown in FIG. 3). Herein, the size measurement module 104 can determine the size of a corresponding AMR frame by scanning the AMR codec mode number (FT) 304 in the header. For example, as shown in FIG. 3, if the AMR codec mode number (FT) 304 is set to 4, with reference to Table 1 it can determine that the corresponding AMR frame has been received at a bit rate of 7.40 kbit/s as a frame of an AMR 7.40 codec mode (corresponding to the AMR codec mode number 4) as shown in Table 1. Accordingly, it can be understood that AMR messages for the corresponding AMR frame are stored in the AMR data field 310 with the size of 148 bits/20 ms frame.

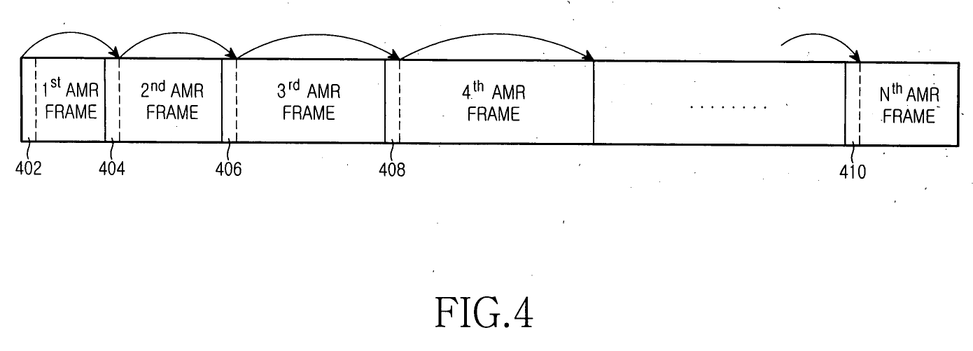

As a result, in an AMR frame having a variable codec format as shown in FIG. 3, the size measurement module 104 checks a header field 300 of the AMR frame so as to determine that the AMR frame includes total 160 bits (a header field 10 bits, an AMR message field 148 bits, and 2 bits for an octet format). If a predetermined AMR message includes a plurality of AMR frames (herein, the frames have different codec rates, but each frame is reproduced for 20 ms) having different codec rates as shown in FIG. 4, the size measurement module 104 can find the total size of the frames by scanning headers 402, 404, 406, 408 and 410 of the frames to determine the sizes of each of the plurality of frames and then by summing the sizes of the frames the total size of the frames is determined.

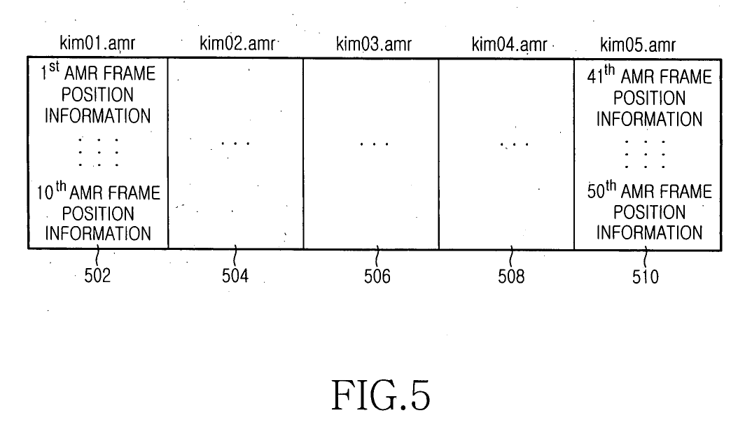

A divided AMR message creation module 106 divides the AMR message by a predetermined size so as to create divided AMR message files. Herein, the division may be performed based on various conditions, including sizes, reproduction times, the numbers of divided groups, etc. In other words, a plurality of AMR frames included in the AMR message are grouped based on a predetermined unit so as to create a plurality of divided AMR messages. For example, if one AMR message including 50 AMR frames is divided into five divided AMR message files as shown in FIG. 5, each of the divided AMR message files 502, 504, 506, 508, and 510 has ten AMR frame addresses as position addresses. In other words, if an AMR message named “kim.amr” is divided into five, divided message files are created with file names such as “kin01.amr” 502, “kim02.amr” 504, “kim03.amr” 506, “kim04.amr” 508, and “kim05.amr” 510 given through a file system in a terminal. Each of the five divided AMR message files has position information of its own AMR frames. For example, the divided AMR message file “kim01.amr” 502 has position information regarding a first AMR frame to a tenth AMR frame. Herein, position information regarding an AMR frame represents a position of a stored frame such as an address of a starting position of an AMR frame header field or of a starting position of an AMR data field. In the AMR reproducing module 108, the divided AMR message is reproduced for each division unit.

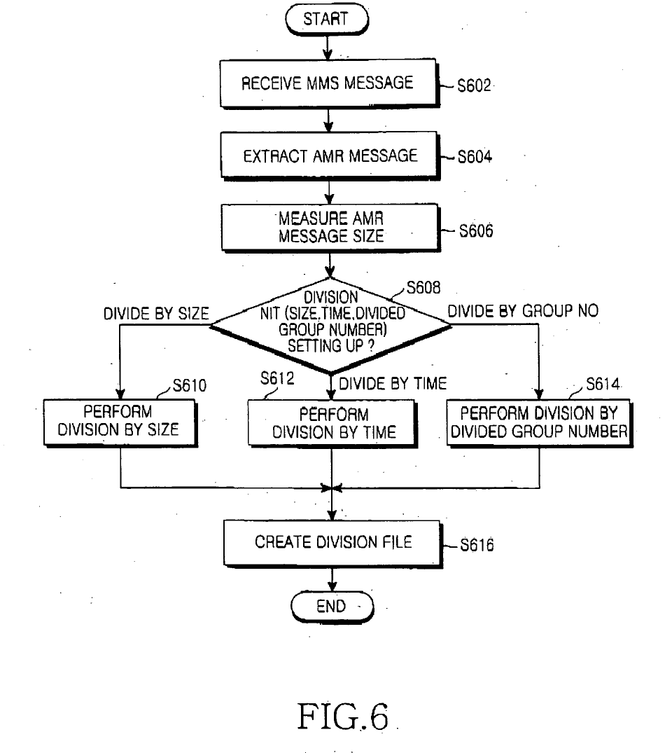

FIG. 6 is a flowchart illustrating a procedure of dividing and storing an AMR message according to the present invention. A mobile telecommunication terminal in a wireless network of a GSM communication system receives an MMS message from a base station (at step S602), the mobile telecommunication terminal using the AMR frame receiving module 102 extracts an AMR message from the received MMS message (at step S604). The AMR message is a voice message that has been processed by an AMR codec and is received through TCH/AFS (an AMR voice channel through FR) and TCH/AHS (an AMR voice channel through HR) of the GSM communication system, and reaches the mobile telecommunication terminal by means of the MMS message. After the AMR message is extracted (at step S604), the size measurement module 104 measures the overall size of AMR frames included in the extracted AMR message (at step S606). Herein, the size measurement module 104 sequentially scans the size of each of plurality of AMR frames included in the AMR message and add then up to yield a total summation for the sizes of the AMR frames. Meanwhile, in the AMR frame size measuring process (at step S606), the size of a corresponding frame can be found by inspecting an AMR codec mode number 304 in each frame header field as shown in FIG. 3.

After the overall size of the AMR frames is measured, a unit for dividing the AMR message is set (at step S608). Herein, the division may be variously achieved. That is, the division may be performed based on various conditions, including specific sizes, specific reproduction times, or the number of divided groups. For example, a user can determine whether the AMR message is divided by 50 kbytes, by 10 seconds, or into ten messages. In order to receive a division unit from a user, the mobile telecommunication terminal can display the overall size or the overall reproducing time of the received AMR message, thereby allowing the user to easily select a division interval. In the meantime, although the division unit may be set by a user as described above, a predetermined division unit may be automatically set by the mobile telecommunication terminal.

After the division unit is set (at step S608), the AMR message is divided with the set division unit (at steps S610, S612, or S614). More specifically, when a user sets the division unit to a specific size, the division module 106 groups the AMR frames by the set specific size. For example, on the assumption that a specific AMR message has N frames and the size of each AMR frame is variable as shown in Table 2 below, when a user sets the division unit in such a manner that the specific AMR message is divided by 50 kbytes, the size of AMR data (95 bits corresponding to the AMR 4.75 codec mode in Table 2) in the first AMR frame is detected, and then, the sizes of the next frames are sequentially added, so that frames added up to a frame at which the overall size is 50 kbytes are bound as a first group. In the same manner, grouping is performed by binding next frames by 50 kbytes (at step S610). Similarly, when it is necessary to set the time-based division as described above, the AMR frames each corresponding to 20 ms are grouped until the grouped frames satisfy the set time unit (for the division) (at step S612).

TABLE 2

| Each frame of AMR message | Size [bits/frame] |
|---|---|
| The first AMR frame (AMR 4.75) | 95 |
| The second AMR frame (AMR 6.70) | 134 |
| The third AMR frame (AMR 5.15) | 103 |
| The fourth AMR frame (AMR 7.40) | 148 |
| The fifth AMR frame (AMR 12.2) | 244 |
| . | . |
| . | . |
| . | . |
| The Nth AMR frame (AMR 5.90) | 118 |

After the division is performed (at any of steps S610, S612, and S614), a division AMR message file, which has identification numbers of grouped frames and header information of the first frame among the grouped frames, is then created (at step S616). The format of the division AMR message file varies depending on a file system of a mobile telecommunication terminal. For example, if an AMR message named “kim.amr” is divided into ten messages, ten division message files named “kim01.amr”, “kim02.amr”, “kim03.amr”, “kim04.amr”, “kim05.amr”, “kim06.amr”, “kim08.amr”, “kim09.amr”, and “kim10.amr” are created.

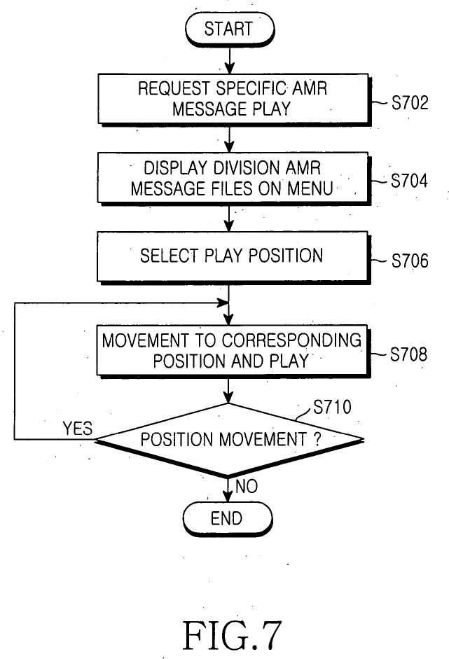

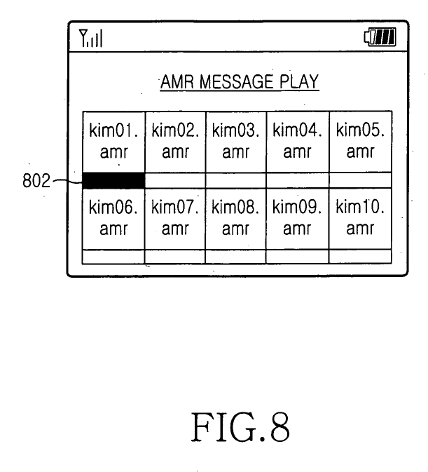

FIG. 7 is a flowchart illustrating a procedure of reproducing a message divided through the procedure of FIG. 6. When a user requests reproduction of a specific AMR message (at step S702), division AMR message files created after dividing the AMR message are displayed (at step S704). The display may be variously achieved. In addition, the division AMR message files may be displayed on a display of the mobile communication terminal in a bar type as shown in FIG. 8. Herein, it is well known to those skilled in the art that the display may be achieved in a bar type as shown in FIG. 8, a disk type, etc.

When the user selects a division AMR message file to be reproduced from among the displayed files by using arrow keys on a key pad (at step S706), the mobile telecommunication terminal marks up the selected file using a selection cursor. If there is no selection, the selection cursor 802 displays on the first division AMR message file in default as shown in FIG. 8. If the selection exists (at step S706), the AMR reproducing module moves to and reproduces a selected division AMR message file (at step S708). When the selected division AMR message file has been completely reproduced, the AMR reproducing module automatically reproduces next division message files up to the last division AMR message file in sequence. Herein, position information of the selected division AMR message file is stored in a corresponding file as described above. In the meantime, when receiving a request for a reproduction position change from the user during the reproduction of an AMR message file (at step S710), the ARM reproducing module moves to the requested reproduction position and starts reproducing an AMR message file from the changed reproduction position.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments shown, but should be defined by the appended claims and equivalents thereof.

What is claimed is:

1. A method for reproducing an adaptive multi-rate message (AMR) in a mobile telecommunication terminal, the method comprising the steps of:
receiving an adaptive multi-rate message decoded by an adaptive multi-rate codec and measuring an overall size of the adaptive multi-rate message;
creating a plurality of division adaptive multi-rate message files, each of which is formed by grouping frames in the AMR message based on a predetermined division unit; and
reproducing a division adaptive multi-rate message file selected by a user from among the created plurality of division adaptive multi-rate message files.

2. The method as claimed in claim 1, wherein the mobile telecommunication terminal belongs to a mobile telecommunication system supporting adaptive multi-rate codec voice.

3. The method as claimed in claim 1, wherein the adaptive multi-rate message includes a voice message extracted from an MMS (multimedia messaging service) message in a GSM telecommunication system.

4. The method as claimed in claim 1, wherein the overall size of the received adaptive multi-rate message is measured by scanning each header information of adaptive multi-rate frames included in the adaptive multi-rate message.

5. The method as claimed in claim 4, wherein the header information includes adaptive multi-rate codec mode information.

6. The method as claimed in claim 1, wherein the division unit is based on one unit selected from among data sizes, times, and numbers of divided groups.

7. The method as claimed in claim 1, wherein the predetermined division unit is set and stored by a user.

8. The method as claimed in claim 1, wherein the division adaptive multi-rate message file has identification numbers of grouped plural adaptive multi-rate frames and position information regarding a header of a first adaptive multi-rate frame in a group.

9. The method as claimed in claim 1, wherein the division adaptive multi-rate message file has a file name according to a file system of a corresponding mobile telecommunication terminal.

10. The method as claimed in claim 1, wherein the division adaptive multi-rate message file reproducing step includes the steps of:
displaying division adaptive multi-rate message files of the adaptive multi-rate message requested to be reproduced;
moving to a division adaptive multi-rate message file selected by a user and reproducing the selected division adaptive multi-rate message file;
sequentially reproducing next frames up to a final adaptive multi-rate message file after finishing reproduction of the adaptive multi-rate message file; and
when the user requests reproduction of another adaptive multi-rate message file during reproduction of the adaptive multi-rate message file, moving to the requested division adaptive multi-rate file and reproducing the requested division adaptive multi-rate message file.

11. The method as claimed in claim 10, wherein the step of displaying division adaptive multi-rate message files is performed by displaying names of the division adaptive multi-rate message files in a bar type.

12. The method as claimed in claim 10, wherein, movement to and reproduction of the requested another division adaptive multi-rate message file are achieved by detecting position information of the requested division adaptive multi-rate message file and moving to the position.

13. An adaptive multi-rate decoder of a mobile telecommunication terminal, comprising:
a receiving module for receiving an adaptive multi-rate message decoded by an adaptive multi-rate codec;
a size measuring module for measuring a size of the received adaptive multi-rate message;
a division adaptive multi-rate message creating module for creating plurality of division adaptive multi-rate message files obtained by dividing the received adaptive multi-rate message based on a predetermined unit; and
an adaptive multi-rate reproducing module for reproducing the division adaptive multi-rate message file.
